(19) United States
(12) Patent Application Publication
(10) Pub. No.: US 2025/0188825 A1
(43) Pub. Date: Jun. 12, 2025

(54) ILLUMINATED MOBILE FRACTURING EQUIPMENT

(71) Applicant: STEWART & STEVENSON LLC, Houston, TX (US)

(72) Inventors: Ricardo RODRIGUEZ, Houston, TX (US); Nicholas TEW, Houston, TX (US); Joseph E. RODRIGUEZ, Houston, TX (US)

(21) Appl. No.: 18/918,460

(22) Filed: Oct. 17, 2024

Related U.S. Application Data
(60) Provisional application No. 63/608,067, filed on Dec. 8, 2023.

(51) Int. Cl. E21B 43/26; F21V 21/22

(52) U.S. Cl. CPC E21B 43/2607; F21V 21/22

(57) ABSTRACT

A fracking system includes a substructure assembly and a transformer cabinet affixed to the substructure assembly. The fracking system also includes at least one pump affixed to the substructure assembly and at least one motor affixed to the substructure assembly. In addition, the fracking system includes a work light affixed to the substructure assembly. The work light includes a base and a telescoping mast affixed to and extending perpendicular to the base. The work light also includes a crosspiece, the crosspiece attached perpendicularly to the telescoping mast and a lamp, the lamp hanging from the crosspiece. The work light also includes a hand crank secured to the telescoping mast, the hand crank mounted between 3 and 5 feet from the ground.

### CROSS-REFERENCE TO RELATED APPLICATIONS

This application is a nonprovisional application which claims priority from U.S. provisional application No. 63/608,067, filed Dec. 8, 2023, which is incorporated by reference herein in its entirety.

### TECHNICAL FIELD/FIELD OF THE DISCLOSURE

The present disclosure relates generally to mobile fracturing equipment, specifically mobile fracturing equipment with an illumination system.

### BACKGROUND OF THE DISCLOSURE

Hydraulic fracturing, referred to herein as fracking, is a method used to enhance hydrocarbon recovery from certain downhole formations. Fracking involves the injection of high-pressure fluid into the downhole formation to induce fracturing of the formation. A proppant is typically included in the fluid used for fracturing. The proppant enters the fractures and retards the closure of the fractures once the fracking operation is completed. The fractures produced may provide additional flow channels for hydrocarbons to escape the formation.

Multiple pieces of wellsite equipment are used during a fracking operation, some of which may be mounted on a trailer. These pieces of wellsite equipment may, during certain times of the day or during certain weather conditions, use illumination sources for operator safety and convenience.

### SUMMARY

The present disclosure provides for a fracking system. The fracking system includes a substructure assembly and a transformer cabinet affixed to the substructure assembly. The fracking system also includes at least one pump affixed to the substructure assembly and at least one motor affixed to the substructure assembly. In addition, the fracking system includes a work light affixed to the substructure assembly. The work light includes a base and a telescoping mast affixed to and extending perpendicular to the base. The work light also includes a crosspiece, the crosspiece attached perpendicularly to the telescoping mast and a lamp, the lamp hanging from the crosspiece. The work light also includes a hand crank secured to the telescoping mast, the hand crank mounted between 3 and 5 feet from the ground.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a perspective view of a mobile fracking system consistent with at least one embodiment of the present disclosure.

FIG. 2 is a perspective view of a work light consistent with certain embodiments of the present disclosure.

FIG. 3 is a perspective view of a work light mount consistent with certain embodiments of the present disclosure.

FIG. 4 is a perspective view of a crank mount consistent with certain embodiments of the present disclosure.

FIG. 5a is a side view of an upper section of the work light consistent with certain embodiments of the present disclosure.

FIG. 5b is an end view cut at B-B of a union attached to a crosspiece consistent with certain embodiments of the present disclosure.

FIG. 6 is a side view of the work light consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

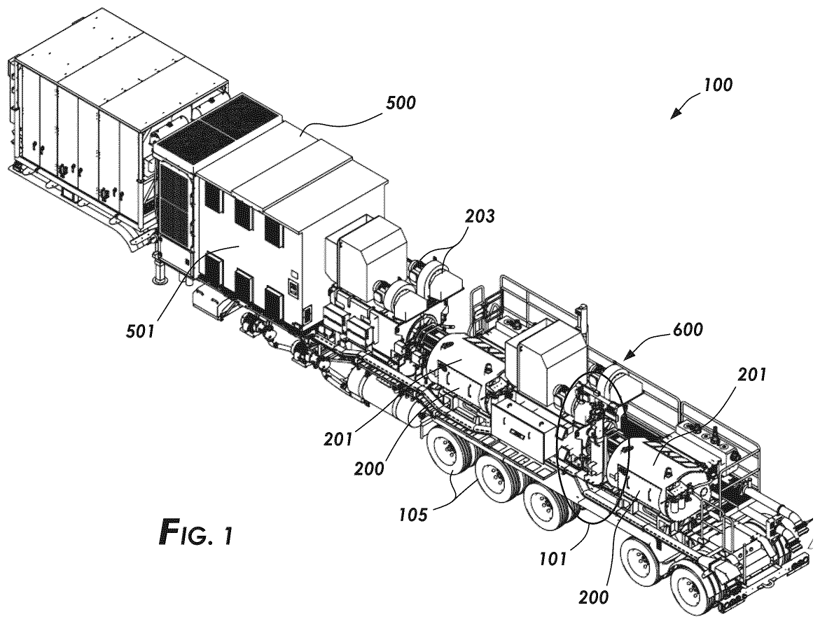

FIG. 1 depicts fracking system 100. Fracking system 100 may be transportable as a single unit. In some embodiments, fracking system 100 may be configured to be road-transportable as a trailer, truck, or part of a trailer or truck. In other embodiments, fracking system 100 may be configured as a skid. In the embodiment shown in FIG. 1, fracking system 100 is configured as a trailer.

In some embodiments, integrated fracking system 100 may include multiple subsystems including, for example and without limitation, pump subsystem 200, and transformer subsystem 500, each of which is further discussed hereinbelow. In some embodiments, each such subsystem may be transported together. In some embodiments, fracking system 100 may be configured such that the subsystems thereof remain operatively connected.

In some embodiments, as further shown in FIG. 1, fracking system 100 may include substructure assembly 101. In some embodiments, substructure assembly 101 may be part of a truck or may make up at least part of a trailer. Substructure assembly 101 may provide support for each subsystem of integrated fracking system 100, as each such subsystem may couple to substructure assembly 101. Substructure assembly 101 may include wheels 105 for use in transporting integrated fracking system 100.

In certain embodiments, as also shown in FIG. 1, fracking system 100 may include frac pumps 201 and motors 203 as part of pump subsystem 200. FIG. 1 further shows transformer subsystem 500 having transformer cabinet 501, within which are housed one or more transformers.

These subsystems of fracking system 100 may use work light 600 for operating efficiency. Due to the size of the fracking system 100 in certain embodiments, multiple work lights 600 may be used.

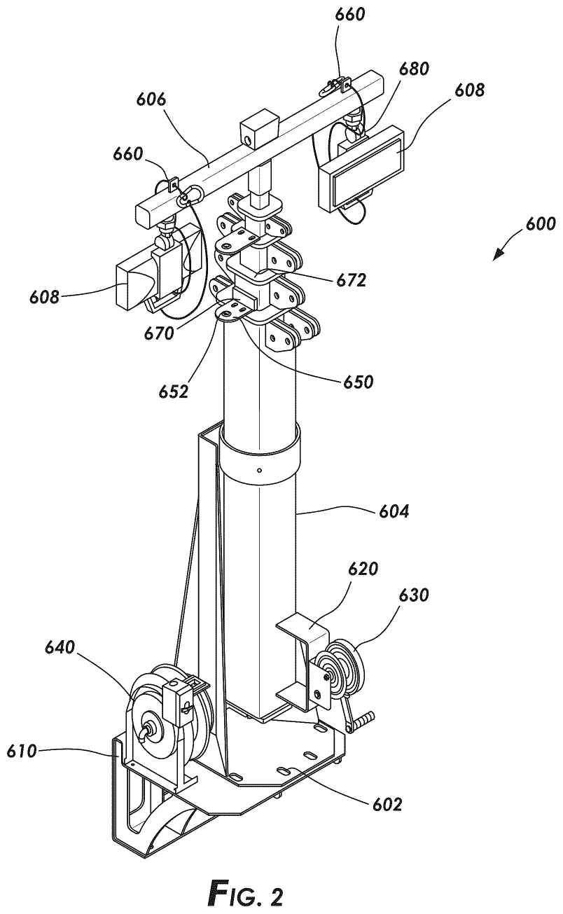

As depicted in FIG. 2, work light 600 may include base 602 and telescoping mast 604 attached thereto and extending therefrom perpendicularly to base 602. Work light 600 may include crosspiece 606 attached to telescoping mast 604 such that crosspiece 606 is perpendicular to telescoping mast 604. Hanging from crosspiece 606 is lamp 608. As shown in FIG. 2, a plurality of lamps 608 may hang from crosspiece 606.

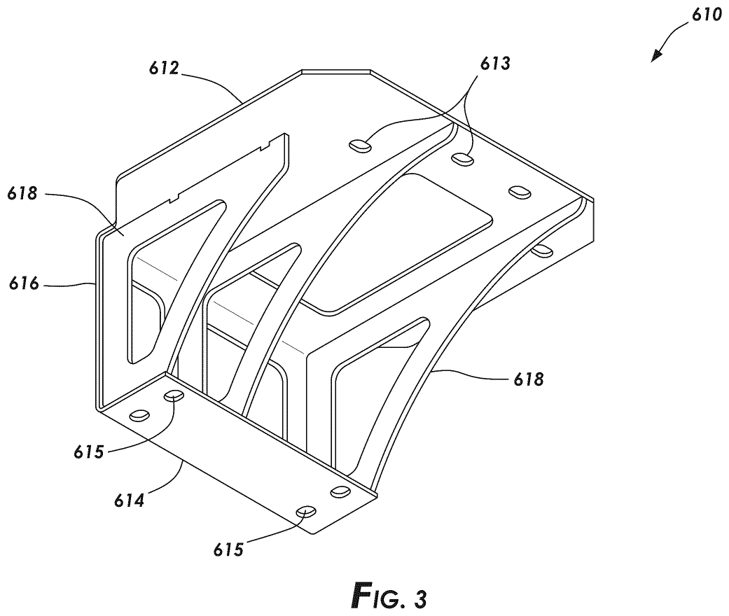

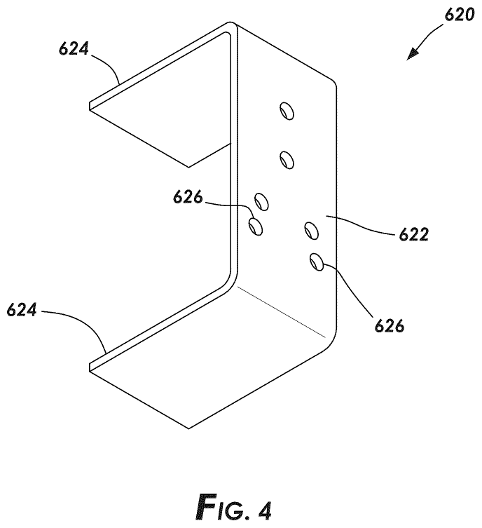

In certain embodiments, such as that shown in FIG. 1, work light 600 may be mounted on substructure assembly 101. Work light mount 610, shown in FIGS. 2 and 3, is affixed to base 602 and substructure assembly 101. As shown in FIG. 3, work light mount 610 may include three elements. The first element is base attachment side 612 for attachment of work light mount 610 to base 602. The second element is substructure attachment side 614 for attachment of work light mount 610 to substructure assembly 101. The third element is connector 616, which connects base attachment side 612 to substructure attachment side 614. Base attachment side 612, connector 616, and substructure attachment side 614 may be formed as a single piece, welded together, or otherwise affixed to each other. In certain embodiments of the present disclosure, base attachment side 612 and substructure attachment side 614 are parallel, with connector 616 being perpendicular to both base attachment side 612 and substructure attachment side 614. In some embodiments, base attachment side 612 and substructure attachment side 614 may be attached by ribs 618 to provide support for work light mount 610. In some embodiments, a plurality of base mounting holes 613 and a plurality of substructure mounting holes 615 may be used to affix work light 600 to substructure assembly 101 using mounting screws or bolts. In some embodiments, work light mount 610 is not used and work light 600 is otherwise affixed to substructure assembly 101, such as by welding.

As shown in FIG. 2, work light 600 may include crank mount 620 affixed to hand crank 630 and telescoping mast 604. In certain embodiments, hand crank 630 may be positioned such that when work light mount 610 is employed, hand crank 630 may be operated from the ground. In such embodiments, hand crank 630 may be mounted between 3 and 5 feet from the ground.

Crank mount 620 may be U-shaped, having two parallel sides 624 joined by middle side 622. Middle side 622 may include a plurality of crank mounting holes 626 for mounting hand crank 630, such as by mounting screws or bolts. Two parallel sides 624 may be welded or otherwise affixed to telescoping mast 604.

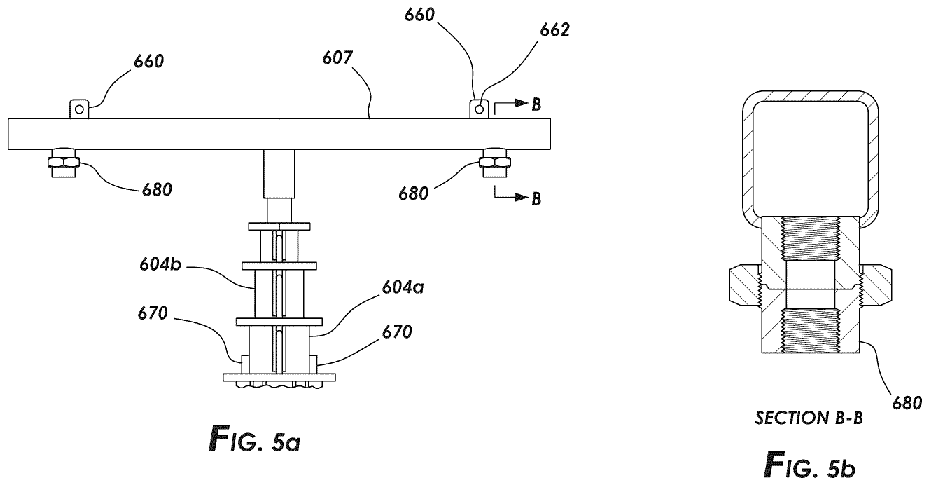

In the embodiment shown in FIG. 2, work light 600 may also include cable reel 640 affixed to base 602. Cable reel 640 may collect and extend the lighting cabling as telescoping mast 604 is raised and lowered. As further shown in FIG. 2, work light 600 may include cable guides 650 affixed to sections of telescoping mast 604. Cable guides 650 may guide lighting cabling to lamp 608. Cable guides 650 shown in FIG. 2 include guide holes 652, but notches may also be used. By using cable guides 650, lighting cabling tangling and entanglement with other parts of work light 600 may be reduced. Similarly, cable tabs 660 may be used to reduce tangling and entanglement of lighting cabling. As shown in FIGS. 2 and 5b, cable tabs 660 are positioned on top surface 607 of crosspiece 606. Cable tabs 660 include tab holes 662 as a cable guide.

In certain embodiments, such as those shown in FIGS. 2 and 5a, sections 604a, 604b of telescoping mast 604 may include mast tabs 670 affixed to those sections. Mast tabs 670 may support the weight of sections 604a, 604b during use of hand crank 630. In certain embodiments, as telescoping mast 604 is lowered, mast ledges 672 may land on mast tabs 670, thereby supporting telescoping mast 604.

In some embodiments of the present disclosure, such as those shown in FIGS. 2, 5a, 5b, and 6, union connector 680 serves to affix lamps 608 to crosspiece 606. With further attention to FIG. 5a, union connector 680 is shown attached to crosspiece 606 (without lamps 608).

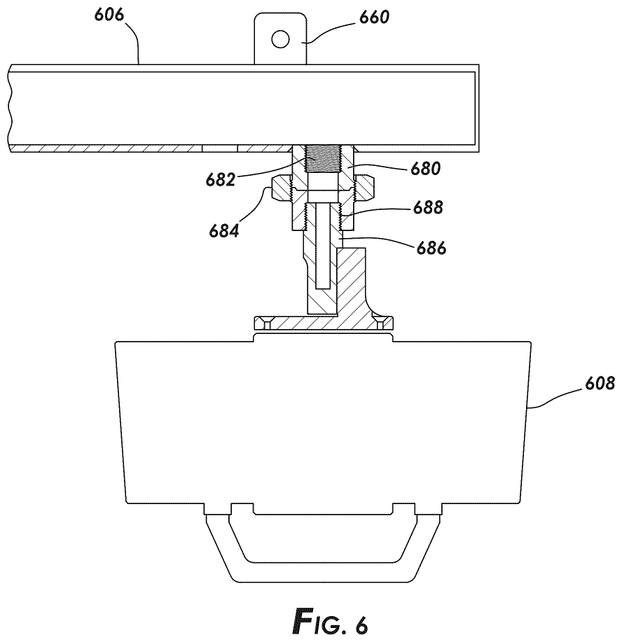

In the embodiments shown in FIG. 6, crosspiece fitting 682 connects crosspiece 606 to union connector 680. Nut 684, when loosened and tightened, makes possible the swiveling of lamp 608 to desired angles and rotations. Union connector 680 allows for full thread engagement (up to 100%) of crosspiece fitting 682. Inner threaded section 688 of union connector 680 allows for a threaded connection with threaded lamp connector 686.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A fracking system comprising:
a substructure assembly;
a transformer cabinet affixed to the substructure assembly;
at least one pump affixed to the substructure assembly;
at least one motor affixed to the substructure assembly; and
a work light affixed to the substructure assembly, wherein the work light includes:
a base;
a telescoping mast affixed to and extending perpendicular to the base;
a crosspiece, the crosspiece attached perpendicularly to the telescoping mast;
a lamp, the lamp hanging from the crosspiece; and
a hand crank secured to the telescoping mast, the hand crank mounted between 3 and 5 feet from the ground.

2. The fracking system of claim 1 further comprising a work light mount, the work light mount affixing the work light to the substructure assembly, the work light mount including:
a base attachment side;
a substructure attachment side; and
a connector, the connector connecting the base attachment side to the substructure attachment side.

3. The fracking system of claim 2, wherein the work light mount is formed as a single piece.

4. The fracking system of claim 2, wherein the work light mount further comprises ribs, the ribs attaching the base attachment side and the substructure attachment side.

5. The fracking system of claim 2, wherein the work light further includes a crank mount, the crank mount connecting the telescoping mast and the hand crank.

6. The fracking system of claim 5, wherein the crank mount is U-shaped having two parallel sides joined by a middle side.

7. The fracking system of claim 5, wherein the work light further includes a cable reel, the cable reel affixed to the base, the cable reel adapted to collect and extend lighting cable.

8. The fracking system of claim 7, wherein the work light further includes a plurality of cable guides, the plurality of cable guides affixed to sections of telescoping sections of the telescoping mast.

9. The fracking system of claim 8, wherein the cable guides include guide holes or notches.

10. The fracking system of claim 8, wherein the work light further includes cable tabs, the cable tabs positioned on a top surface of the crosspiece.

11. The fracking system of claim 10, wherein the cable tabs include tab holes.

12. The fracking system of claim 10, wherein the work light further includes mast tabs, the mast tabs affixed to the telescoping sections.

13. The fracking system of claim 12, wherein the work light further includes a union connector, the union connector positioned to affix the lamps to the cross piece.

14. The fracking system of claim 12, wherein union connector is adapted to allow the lamp to swivel.
